(19) United States
(12) Patent Application Publication
(10) Pub. No.: US 2004/0017059 A1
(43) Pub. Date: Jan. 29, 2004

(54) Relief sleeve for bicycle handlebar assembly

(76) Inventor: Cheng-Xun Jiang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/200,319

(22) Filed: Jul. 23, 2002

(51) Int. Cl. B62K 1/00

(52) U.S. Cl. 280/279

(57) ABSTRACT

A handlebar assembly for bicycles includes a handlebar stem and a clamping member is connected to the handlebar stem. A handlebar extends through the clamping member and a relief sleeve is mounted to the handlebar and sandwiched between the handlebar and the clamping member. The relief sleeve has holes which release stress applied to the handlebar.

### FIELD OF THE INVENTION

The present invention relates to a relief sleeve mounted to the handlebar which is secured to the handlebar stem by a clamping member. The relief sleeve has multiple holes for releasing stress applied to the handlebar.

### BACKGROUND OF THE INVENTION

A conventional bicycle handlebar assembly includes a handlebar stem which has a clamping member connected to a distal end of the stem and the handlebar is clamped by the clamping member by a bolt. The clamping member is a tubular member with an elongated slot and two lugs extend from two edges defining the slot. The handlebar extends through the clamping member and is secured by connecting the two lugs by the bolt. The conventional handlebar assembly is found to have stress concentration for the handlebar made of carbon-fiber. Although the carbon-fiber is a light and durable material, it has less flexibility and could be broken when a sudden stress applied onto the handlebar.

The present invention intends to provide a relief sleeve that is sandwiched between the handlebar and the clamping member so as to release the stress onto the handlebar.

### SUMMARY OF THE INVENTION

In accordance with one aspect of the present invention, there is provided a handlebar assembly for bicycles and the assembly comprises a handlebar stem which is connected between a steerer tube and a clamping member through which a handlebar extends. A relief sleeve is mounted to the handlebar and sandwiched between the handlebar and the clamping member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the handlebar assembly of the present invention;

FIG. 2 is an exploded view to show the handlebar assembly of the present invention; and

FIG. 3 shows the cross sectional view of the handlebar assembly of the present invention.

### DETAILED DESCRIPTION OF THE PREFERRED EMBODIMENT

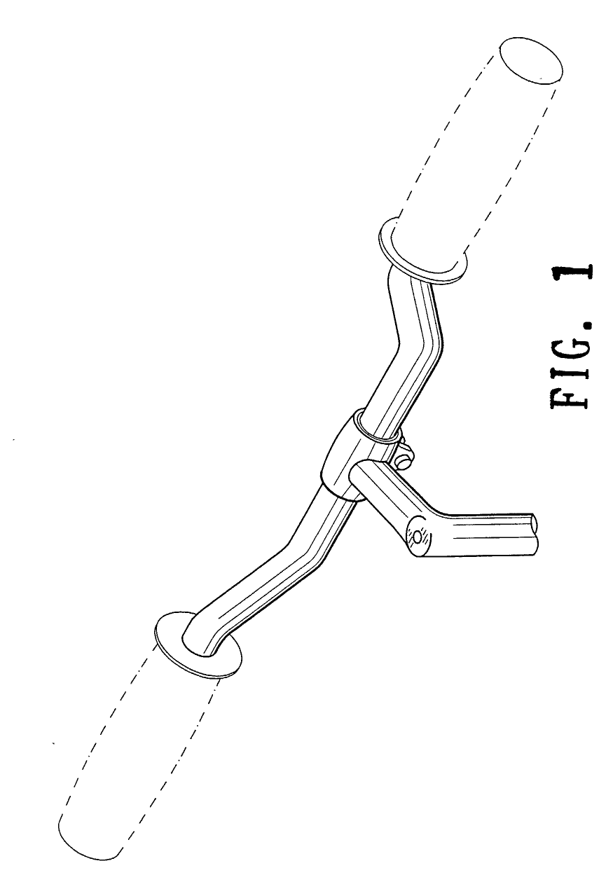

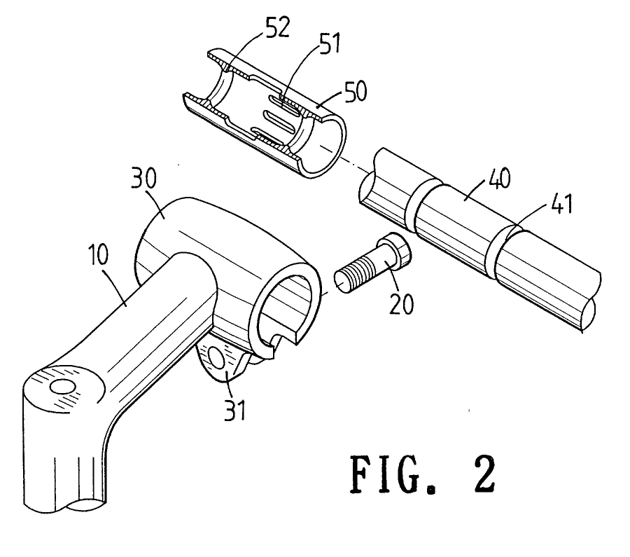

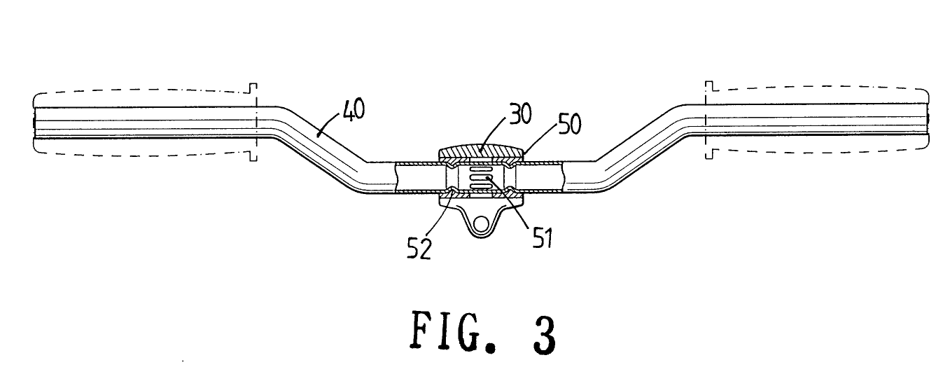

Referring to FIGS. 1 to 3, the handlebar assembly of the present invention comprises a handlebar stem 10 which has a first end connected to a steerer tube (not shown) and a second end of the handlebar stem 10 is connected to a clamping member 30 which has an elongate slot 32 and two lugs 31 extend from two edges defining the elongate slot 32. A bolt 20 extends through the two lugs 31 to securely clamp a handlebar 40 extending through the clamping member 30.

A relief sleeve 50 is mounted to the handlebar 40 and sandwiched between the handlebar 40 and the clamping member 30. The relief sleeve 50 has two slots 51 defined therethrough and two ridges 52 extend from an inner periphery of the relief sleeve 50. The handlebar 40 has two grooves 41 defined in an outer periphery thereof so that the ridges 52 are engaged with the grooves 41 to prevent the relief sleeve 50 from slipping relative to the handlebar 40.

The relief sleeve 50 is made of soft and flexible material, and the slots 51 releases the stress applied to the handlebar 40 so that when the bolt 20 securely connects the two lugs 31 together, the relief sleeve 50 is deformed to absorb the stress supposed to be applied onto the handlebar 40. This is especially important for the carbon-fiber handlebar 40.

While we have shown and described the embodiment in accordance with the present invention, it should be clear to those skilled in the art that further embodiments may be made without departing from the scope of the present invention.

What is claimed is:

1. A handlebar assembly for bicycles, comprising:
a handlebar stem and an end of the handlebar stem connected to a clamping member;
a handlebar extending through the clamping member, and
a relief sleeve mounted to the handlebar and sandwiched between the handlebar and the clamping member.

2. The handlebar assembly as claimed in claim 1, wherein the relief sleeve has a plurality of slots defined therethrough.

3. The handlebar assembly as claimed in claim 1, wherein the handlebar has a plurality of grooves defined in an outer periphery thereof and the relief sleeve has ridges extending from an inner periphery thereof, the ridges engaged with the grooves.

4. The handlebar assembly as claimed in claim 1, wherein the clamping member has an elongate slot and two lugs extend from two edges defining the elongate slot, a bolt extending through the two lugs to securely clamp the handlebar.
